(19) United States
(12) Patent Application Publication
(10) Pub. No.: US 2017/0306970 A1
(43) Pub. Date: Oct. 26, 2017

(54) EXTRAPOLATION METHOD OF LOW ROTATIONAL SPEED CHARACTERISTIC OF COMPRESSOR

(71) Applicant: Institute of Engineering Thermophysics, Chinese Academy of Sciences, Beijing (CN)

(72) Inventors: Detang Zeng, Beijing (CN); Chunqing Tan, Beijing (CN); Qing Gao, Beijing (CN); Meiyuan Li, Beijing (CN); Yongjun Zhang, Beijing (CN); Haisheng Chen, Beijing (CN)

(21) Appl. No.: 15/413,677

(22) Filed: Jan. 24, 2017

(30) Foreign Application Priority Data
Apr. 26, 2016 (CN) 201610265378.3

(51) Int. Cl. F04D 27/00; G06F 17/17

(52) U.S. Cl. CPC F04D 27/001; G06F 17/17

(57) ABSTRACT

The present disclosure provides an extrapolation method of low rotational speed characteristics of a compressor, which is suitable for acquisition the low rotational speed characteristics of a gas turbine on the ground or an aircraft engine, the extrapolation method takes into account an application condition of a similarity principle and specialties of the low rotational speed operation condition of the compressor, and comprises modifying exponents of the similarity principle to obtain the optimal exponents by an optimization algorithm, and applying a coefficient fitting method for a variable operating condition calculation of the gas turbine to the extrapolation of low rotational speed characteristic of the compressor to obtain the low rotational speed characteristic.

### CROSS-REFERENCE TO RELATED APPLICATION

This application claims the benefit of Chinese Patent Application No. 201610265378.3 filed on Apr. 26, 2016 in the State Intellectual Property Office of China, the whole disclosure of which is incorporated herein by reference.

### BACKGROUND

### Technical Field

The present disclosure generally relates to a method for acquisition low rotational speed characteristics of a gas turbine or an aircraft engine, and specifically relates to a modified extrapolation method of characteristics of a gas turbine or an aircraft engine based on exponents of the similarity principle.

### Description of the Related Art

Compressor characteristic is an important indicator to judge a compressor's performance, and it is difficult to obtain the compressor characteristic at a low rotational speed with an experiment method or a CFD numerical method. In order to solve the problem of obtaining a low rotational speed characteristic of a compressor, Sexton proposed that, under similar operation conditions, the low rotational speed characteristic of the compressor is extrapolated through a n-power relationship between a flow rate, the work and the power of a working medium and the rotational speed, without taking into account the influence of the compressibility of the working medium on the low rotational speed characteristic. On basis of Sexton's research, Yi DING proposed that, taking into account the influence of other neglected factors on the characteristics, under similar operation conditions, the low rotational speed characteristic of the compressor is extrapolated through empirical correction coefficients as well as a n-power relationship working medium between the flow rate, the work and the power of the working medium and the rotational speed.

The present disclosure is intended to solve the problem that the existing extrapolation method of a low rotational speed characteristic of a compressor does not take into account the influence of the compressibility of the working medium on the low rotational speed characteristic, and to solve the shortcomings of the existing methods. It is provided a method to obtain the low rotational speed characteristic of the compressor by modifying the exponents of the similarity principle with an optimization algorithm, which takes into account the influence of the working medium compressibility on the exponents of the similarity principle. The present disclosure is proposed in this context.

For the problem of obtaining the low rotational speed characteristic of a compressor, the present disclosure provides an extrapolation method of a low rotational speed characteristic of a compressor, which is suitable for acquisition the low rotational speed characteristics of a gas turbine on the ground and an aircraft engine, characterized in that, according to an application condition of the similarity principle and specialties of the low rotational speed operation condition of the compressor, a method for modifying the exponents of extrapolated characteristics based on the similarity principle is proposed, optimal exponents are obtained by a genetic algorithm, and a coefficient fitting method of the gas turbine under variable operation conditions is applied to the extrapolation of a low rotational speed characteristic of a compressor to obtain the low rotational speed characteristics.

### SUMMARY

The present disclosure is intended to solve a problem that it is difficult to obtain the low rotational speed characteristic of the compressor, and drawbacks in the existing extrapolation method of a low rotational speed characteristic of a compressor based on the similarity principle. According to an application condition of a similarity principle and specialties of the low rotational speed operation condition of the compressor, in the present disclosure, the similarity principle is modified, and an extrapolation method of the low rotational speed characteristics of a gas turbine or an aircraft engine based on the similarity principle is proposed, and optimal exponents are obtained by an optimization algorithm, the low rotational speed characteristics such as m_{cor}−φ, m_{cor}−π and m_{cor}−ηₛ are obtained by fitting, a coefficient fitting method of the gas turbine under variable operation conditions is applied to the extrapolation of a low rotational speed characteristic of a compressor, achieving extrapolation of the low rotational speed characteristics of the compressor from high rotational speed characteristics of the compressor.

The present disclosure provides following technical solutions for solving the problems:

an extrapolation method of a low rotational speed characteristic of a compressor based on the similarity principle, comprising, in sequence, modifying the similarity principle, obtaining an optimal exponent, and calculating the low rotational speed characteristic of the compressor, wherein:

SS1. modifying the similarity principle:

taking into account the influence of gas compressibility on the exponent of the similarity principle, modifying equations of the similarity principle into Equations (1)-(3), under a condition that an inlet angle of the compressor is constant, each level of internal flow field of the compressor satisfies a dynamic self-similarity, and speed-triangles of the inlet and outlet under similar operation conditions satisfy akinesiology similarity and a geometric similarity

$$\begin{matrix}\frac{{m}_{1}}{{m}_{2}} = {( \frac{{n}_{1}}{{n}_{2}} )}^{x} & ( 1 ) \\ \frac{{W}_{1}}{{W}_{2}} = {( \frac{{n}_{1}}{{n}_{2}} )}^{y} & ( 2 ) \\ \frac{{N}_{1}}{{N}_{2}} = {( \frac{{n}_{1}}{{n}_{2}} )}^{z} & ( 3 )\end{matrix}$$

Where Eq. (1) is a flow rate similarity equation, Eq. (2) is a work similarity equation. Eq. (3) is a power similarity equation, x refers to an exponent of the flow rate similarity equation, y refers to an exponent of the work similarity equation and z refers to an exponent of the power similarity equation; m is the flow rate, W is the compression shaft work, N is the shaft power, n is the rotational speed, and the subscripts 1 and 2 refer to different operation conditions:

a relationship between a working medium work and the flow rate is known as follows:

W=N/m (4)

it can be derived by combining Eqs. (1)-(4) as follows:

$$\frac{{N}_{1} / {m}_{1}}{{N}_{2} / {m}_{2}} = {( \frac{{n}_{1}}{{n}_{2}} )}^{x - z} \qquad ( 5 )$$

according to definition of isentropic efficiency:

$${η}_{s} = \frac{m \cdot {W}_{i}}{N} = \frac{m \cdot {C}_{p} ( {π}^{( ka - 1 ) / ka} - 1 )}{N} \qquad ( 6 )$$

Where ηₛ is the compressor's isentropic efficiency, π is the pressure ratio, and ka is the ratio of specific heat capacity ratio,

With Eqs. (5)-(6), a relationship equation (7) between efficiency and pressure ratio based on the similarity principle is obtained as follows:

$$\frac{{η}_{s 1} / ( {π}_{1}^{( ka - 1 ) / ka} - 1 )}{{η}_{s 2} / ( {π}_{2}^{( ka - 1 ) / ka} - 1 )} = {( \frac{{n}_{1}}{{n}_{2}} )}^{x - z} \qquad ( 7 )$$

using a curve of the pressure ratio r, isentropic efficiency ηₛ, the relative converted rotational speed n̅_{cor} and converted flow rate m_{cor} to express the characteristics of components of the compressor to obtain a further modified relationship Eqs. (8)˜(10) of the similarity principle as follows:

$$\begin{matrix}\frac{{m}_{cor 1}}{{m}_{cor 2}} = {( \frac{{\overline{n}}_{cor 1}}{{\overline{n}}_{cor 2}} )}^{x} & ( 8 ) \\ \frac{{φ}_{1}}{{φ}_{2}} = {( \frac{{\overline{n}}_{cor 1}}{{\overline{n}}_{cor 2}} )}^{x - z} & ( 9 ) \\ φ = \frac{{η}_{s}}{{π}^{( ka - 1 ) / ka} - 1} & ( 10 )\end{matrix}$$

where

$${\overline{n}}_{cor} = \frac{n / \sqrt{{T}_{in}}}{{n}_{des} / \sqrt{{T}_{des}}}$$

is the relative converted rotational speed:

$${m}_{cor} = m \cdot \sqrt{\frac{{T}_{in}}{288.15}} \times \frac{101325}{{p}_{in}}$$

is the converted flow rate: Tᵢₙ is the inlet temperature; T_{des} the inlet design temperature; n_{des} is the design rotational speed; pᵢₙ is the inlet pressure; among the subscripts, cor refers to the conversion parameter; φ is the defined pressure ration efficiency coefficient.

SS2: obtaining the optimal exponent, comprising establishing an objective function and optimizing the exponent, wherein, the optimization goal is in that: for each group of similar operation conditions, the optimized exponents are obtained such that a sum of errors of the modified similarity principle between every two similar operation conditions is minimized. Optimization principle includes modeling an optimization problem as a process of biological evolution, generating a better solution set generation by generation in accordance with the principle of survival of the fittest, choosing the solution in each generation of solution set according to the fitness function value and generating the next generation of solution by crossing and mutating of the genetic operator, and the optimal solution of the problem is obtained until the termination condition of the algorithm is satisfied.

Firstly, an objective function as Eq. (11) is established, secondly the objective function is used as a fitness function, the exponent is optimized by an optimization algorithm, such that optimal exponents xⱼ and zⱼ for j groups of similar operation conditions are obtained. When performing the optimization, the optimization goal is in that: for each group of similar operation conditions, the optimized exponents are obtained such that a sum of errors of the modified similarity principle between every two similar operation conditions is minimized. Optimization principle includes modeling an optimization problem as a process of biological evolution, generating a better solution set generation by generation in accordance with the principle of survival of the fittest, choosing a solution in each generation of solution set according to the fitness function value and generating the next generation of solution by crossing and mutating of the genetic operator, and the optimal solution of the problem is obtained until the termination condition of the algorithm is satisfied,

$${f}_{index} ( x , z ) = {\sum }_{i = 1}^{a - 1} {\sum }_{b = i + 1}^{a} [ \frac{\vert \frac{{m}_{cori}}{{m}_{corb}} - {( \frac{{\overline{n}}_{cori}}{{\overline{n}}_{corb}} )}^{x} \vert}{\frac{{m}_{cori}}{{m}_{corb}}} ] + {\sum }_{i = 1}^{a - 1} {\sum }_{b = i + 1}^{a} [ \frac{\vert \frac{{φ}_{cori}}{{φ}_{corb}} - {( \frac{{\overline{n}}_{cori}}{{\overline{n}}_{corb}} )}^{x - z} \vert}{\frac{{φ}_{cori}}{{φ}_{corb}}} ] \qquad ( 11 )$$

where a refers to the total number of the known rotational speed lines, and each of the rotational speed lines has totally j operation conditions, which constitute j groups of similar operation conditions, so the j groups of similar operation conditions are optimized and ultimately optimal exponents xⱼ and zⱼ of the j groups of similar operation conditions are obtained: m_{cori} is the converted flow rate of the operation conditions of the rotational speed line n̅_{cori}, and φ_{cori} is the pressure ration efficiency coefficient of the operation conditions of the rotational speed line n̅_{cori}, m_{corb} is the converted flow rate of the operation conditions of the rotational speed line n̅_{corb}; φ_{corb} is the pressure ration efficiency coefficient of the operation conditions of the rotational speed line n̅_{corb}; the subscript i, b refer to the variable in the algorithm and refer to different rotational speed lines.

SS3. calculating the low rotational speed characteristic of the compressor, comprises the extrapolation calculation of flow rate, extrapolation calculation of pressure ratio and the extrapolation calculation of efficiency, wherein

applying the optimal exponents xⱼ and zⱼ to the similar conditions of the respective rotational speeds as shown in Eqs. (12) and (13),

m̅_{cori}^{j}=m_{cori}^{j}×(n̅_{cor0}/n̅_{cori})^{x}^{ⱼ} (12)

φ̅_{cori}^{j}=φ_{cori}^{j}×(n̅_{cor0}/n̅_{cori})^{z}^{ⱼ} (13)

where m̅_{cori}^{j} is the relative converted flow rate, φ̅_{cori}^{j} is the relative pressure ration efficiency coefficient; subscript 0 refers to the operation conditions of the rotational speed line to be calculated, the subscript i refers to the operation conditions on a known rotational speed line, the superscript j refers to the group number of the similar operation conditions.

For each group of similar operation conditions, performing a polynomial fitting to m̅_{cori}^{j} and φ̅_{cori}^{j} with respect to n̅_{cori} respectively, the fitting relations are Eqs. (14), (15), the converted flow rate m_{cor} and the pressure ration efficiency coefficient φ of the rotational speed line to be calculated are obtained, as shown in Eqs. (16) and (17):

m̅_{cori}^{j}=Fⱼ(n̅_{cori}) (14)

φ̅_{cori}^{j}=Rⱼ(n̅_{cori}) (15)

m_{cor}=Fⱼ(n̅_{cor0}) (16)

φ=Rⱼ(n̅_{cor0}) (17)

then calculating the pressure ratio π of the rotational speed line to be calculated according to a coefficient fitting method:

for a known rotational speed line, performing a polynomial fitting to the pressure ratio π with respect to flow rate m_{cor}, the fitting relationship is Eq. (18), and performing a fitting to the coefficient A_{bi} with respect to the relative converted rotational speed n̅_{cor}, as shown in Eq. (19), a relationship of π with respect to m_{cor} and n̅_{cor} is shown in Eq. (20), and the pressure ratio π of the rotational speed line to be calculated is obtained as follows:

πᵢ=A₀ᵢ+A₁ᵢm_{cor}+ . . . +A_{ci}m_{cor}^{c}, (18)

A_{bi}=g_{bi}(n̅_{cor}) (19)

π=G(m_{cor},n̅_{cor}) (20)

finally calculating the efficiency ηₛ of the rotational speed line to be calculated with Eq. (21),

ηₛ=φ×(π^{(k-1)/k}−1) (21)

where A_{bi} (b=0, 1, . . . , c−1, c) is the coefficient of the fitting polynomial and subscript i is the operation condition of the known rotational speed line.

Further, the extrapolation method of a low rotational speed characteristic of a compressor based on the similarity principle according to the present disclosure, the rationality of the calculated results may be verified by comparing them with experimental data and the extrapolated results using the similarity principle directly.

Further, in step SS1, investigating influence of the gas compressibility on the exponent of the similarity principle by investigating the difference between the exponent x in the flow rate similarity equation (1) and 1, or by investigating the difference between the exponent yin the work similarity equation (2) and 2, or by investigating the difference between the exponent z in the exponent of the power similarity equation (3) and 3.

Further, in step SS2, for each group of similar operation conditions, establishing an objective function with an objection that the optimized exponents are obtained such that the sum of the error of the modified similarity principle between every two similar operation conditions is minimized.

Further, in step SS2, the exponents are optimized by a genetic algorithm and obtaining the optimal exponents xⱼ and zⱼ of j groups of similar operation conditions. Further, the following steps are included when optimizing the exponents by the genetic algorithm, modeling an optimization problem as a process of biological evolution, and generating a better solution set by generation, choosing a better solution in each generation of solution set according to the fitness function value and generating the next generation of solution by crossing and mutating of the genetic operator, until evaluating to the largest genetic algebra, and ultimately obtaining the optimal exponents, minimizing the sum of the error of the modified similarity principle between every two similar operation conditions.

Further, the extrapolation method of a low rotational speed characteristic of a compressor according to the present disclosure is applicable to a device which needs to obtain the low rotational speed characteristic of a compressor, such as a gas turbine and an aircraft engine.

Compared with the prior arts, the extrapolation method of a low rotational speed characteristic of a compressor based on the similarity principle according to the present disclosure has following significant advantages: 1) the present disclosure takes into account the influence of the compressibility of the working medium on the exponents of the similarity principle; 2) the exponents of the similarity principle are quickly optimized by the genetic optimization algorithm and the low rotational speed characteristic of the compressor may be quickly obtained.

### BRIEF DESCRIPTION OF THE DRAWINGS

FIG. 1 is a flow chart of an extrapolation method of a low rotational speed characteristic of a compressor;

FIG. 2 is a flow chart of an exponent optimization based on a genetic algorithm:

FIG. 3 is an experimental data chart of m_{cor}−φ for a compressor of a turbofan engine of a certain type:

FIG. 4 is a flow chart showing m_{cor}−φ extrapolation calculation of a compressor;

FIG. 5 is a diagram showing m_{cor}−φ extrapolation results of a compressor of a turbofan engine of a certain type;

FIG. 6 is a flow chart showing m_{cor}−π extrapolation calculation of a compressor;

FIG. 7 is a diagram showing m_{cor}−π extrapolation results of a compressor of a turbofan engine of a certain type;

FIG. 8 is a flow chart showing m_{cor}−ηₛ extrapolation calculation of a compressor; and

FIG. 9 is a diagram showing m_{cor}−ηₛ extrapolation results of a compressor of a turbofan engine of a certain type;

where f_{index}(x,z) is the fitness function, and X′(t) and Z′(t) are the optimal exponents of each group of similar operation conditions.

### DETAILED DESCRIPTION OF PREFERRED EMBODIMENTS

In order that the objects, technical solutions and advantages of the present disclosure will become more apparent, the present disclosure will be described in detail by way of example with reference to the accompanying drawings. It is to be noted that the following description is only preferred embodiments of the present invention and does not limit the scope of the present invention.

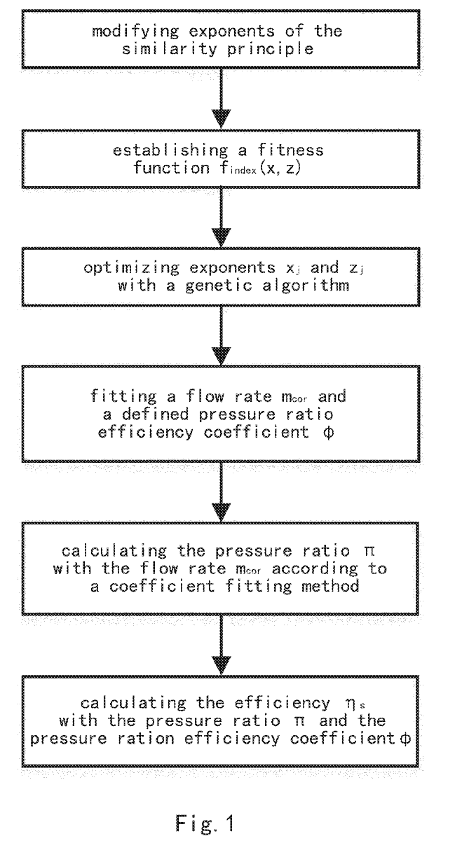

As shown in FIG. 1, an extrapolation method of a low rotational speed characteristic of a compressor based on the similarity principle according to the present disclosure comprises steps such as modifying the similarity principle, obtaining an optimal exponent, and calculating low rotational speed characteristics of a compressor.

SS1. modifying the similarity principle:

For an incompressible fluid, the similarity principle is expressed as Equations (1), (2′) and (3′):

$$\begin{matrix}\frac{{m}_{1}}{{m}_{2}} = {( \frac{{n}_{1}}{{n}_{2}} )}^{x} & ( 4 ) \\ \frac{{W}_{1}}{{W}_{2}} = {( \frac{{n}_{1}}{{n}_{2}} )}^{2} & ( {2}^{’} ) \\ \frac{{N}_{1}}{{N}_{2}} = {( \frac{{n}_{1}}{{n}_{2}} )}^{3} & ( {3}^{’} )\end{matrix}$$

Where m is the flow rate, W is the work made by a compression shaft, N is the power of the shaft, n is the rotational speed, x=1 is the exponent of the flow rate similarity equation and the subscripts “1” and “2” refer to different operation conditions.

Making analysis to the characteristics of a certain type of the turbofan engine when the rotation speed is n̅_{cor}=0.5, n̅_{cor}=0.6, n̅_{cor}=0.7 and n̅_{cor}=0.8, and calculating the exponent x of the flow rate similarity equation by taking Eq. (1) and the characteristics corresponding to the rotation speed n̅_{cor}=1 as a base point, it is found that the exponent x is within a range of 1.2968 to 2.4711, which is substantially different from 1, it is thus concluded that the gas compressibility has a greater influence on the exponent.

Under a condition that an inlet angle of the compressor is constant, stages of internal flow field of the compressor each satisfy a dynamic self-similarity, and an inlet and outlet speed-triangle under a similar operation condition satisfies a kinematic similarity and a geometric similarity, the exponents of the above equations (1), (2′) and (3′) are changed to x, y, z, as shown in following equations (1), (2) and (3):

$$\begin{matrix}\frac{{m}_{1}}{{m}_{2}} = {( \frac{{n}_{1}}{{n}_{2}} )}^{x} & ( 1 ) \\ \frac{{W}_{1}}{{W}_{2}} = {( \frac{{n}_{1}}{{n}_{2}} )}^{y} & ( 2 ) \\ \frac{{N}_{1}}{{N}_{2}} = {( \frac{{n}_{1}}{{n}_{2}} )}^{z} & ( 3 )\end{matrix}$$

where x refers to an exponent of the flow rate similarity equation, y refers to an exponent of the work similarity equation and z refers to an exponent of the power similarity equation.

A relationship equation (7) between an efficiency and a pressure ratio based on the similarity principle is obtained in combination with a relationship equation (4) between the work and the flow rate of the working medium, and is applied to calculation of the low rotational speed characteristics of the compressor.

$$\begin{matrix}W = N / m & ( 4 ) \\ \frac{{N}_{1} / {m}_{1}}{{N}_{2} / {m}_{2}} = {( \frac{{n}_{1}}{{n}_{2}} )}^{x - z} & ( 5 ) \\ {η}_{s} = \frac{m \cdot {W}_{i}}{N} = \frac{m \cdot {C}_{p} ( {π}^{( ka - 1 ) / ka} - 1 )}{N} & ( 6 ) \\ \frac{{η}_{s 1} / ( {π}_{1}^{( ka - 1 ) / ka} - 1 )}{{η}_{s 2} / ( {π}_{2}^{( ka - 1 ) / ka} - 1 )} = {( \frac{{n}_{1}}{{n}_{2}} )}^{x - z} & ( 7 )\end{matrix}$$

where ηₛ is the compressor's isentropic efficiency, π is the pressure ratio, and ka is a specific heat capacity ratio.

Characteristics of components of the compressor are usually represented by a curve showing the pressure ratio π, the isentropic efficiency ηₛ, a relative converted rotational speed n̅_{cor} and a converted flow rate m_{cor}, as shown in equation (22), to obtain a further modified similarity principle as shown in relationship equations (8)˜(10):

$$\{ \begin{matrix}π = {F}_{1} ( {\overline{n}}_{cor} , {m}_{cor} ) \\ {η}_{s} = {F}_{2} ( {\overline{n}}_{cor} , {m}_{cor} )\end{matrix} \qquad ( 22 )$$

where

$${\overline{n}}_{cor} = \frac{n / \sqrt{{T}_{in}}}{{n}_{des} / \sqrt{{T}_{des}}}$$

is the relative converted rotational speed,

$${m}_{cor} = m \cdot \sqrt{\frac{{T}_{in}}{288.15}} \times \frac{101325}{{p}_{in}}$$

is the converted flow rate. Tᵢₙ is an inlet temperature, T_{des} an inlet design temperature, n_{des} a design rotational speed, and pᵢₙ is an inlet pressure, among the subscripts, cor refers to a conversion parameter.

$$\begin{matrix}\frac{{m}_{cor 1}}{{m}_{cor 2}} = {( \frac{{\overline{n}}_{cor 1}}{{\overline{n}}_{cor 2}} )}^{x} & ( 8 ) \\ \frac{{φ}_{1}}{{φ}_{2}} = {( \frac{{\overline{n}}_{cor 1}}{{\overline{n}}_{cor 2}} )}^{x - z} & ( 9 ) \\ φ = \frac{{η}_{s}}{{π}^{( ka - 1 ) / ka} - 1} & ( 10 )\end{matrix}$$

where φ is a defined pressure ratio efficiency coefficient, and the subscripts “1” and “2” refer to different operation conditions.

SS2. obtaining the optimal exponent, including

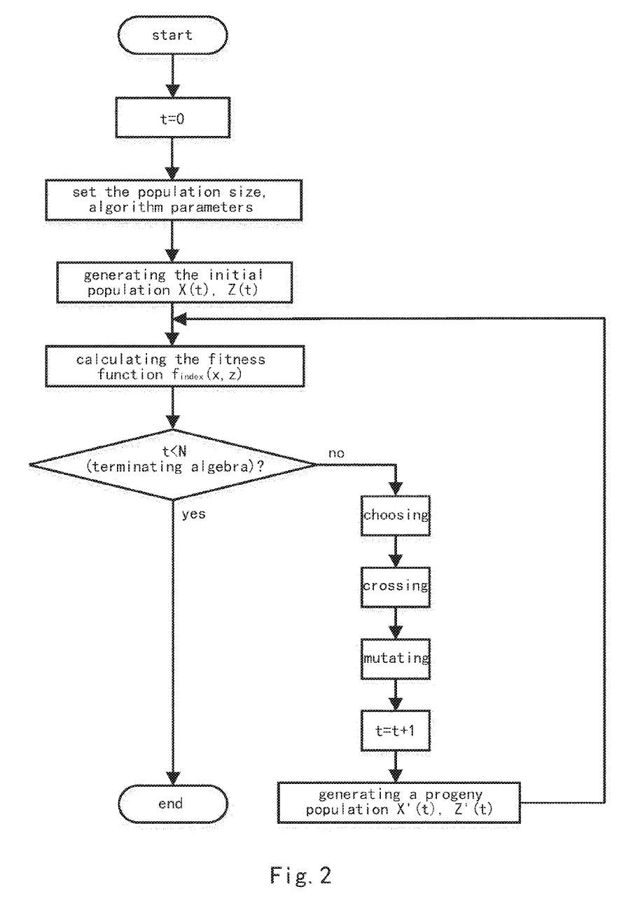

establishing an objective function as equation (11) and then taking the objective function as a fitness function, and optimizing the exponent by a genetic algorithm and obtaining optimal exponents xⱼ and zⱼ for j groups of similar operation conditions, a flow chart of the exponent optimization based on the genetic algorithm is shown in FIG. 2.

the optimization goal is in that: for each group of similar operation conditions, the optimized exponents are obtained such that a sum of errors of the modified similarity principle between every two similar operation conditions is minimized. Optimization principle includes modeling an optimization problem as a process of biological evolution, generating a better solution set generation by generation in accordance with the principle of survival of the fittest, choosing a solution in each generation of solution set according to the fitness function value and generating the next generation of solution by crossing and mutating of the genetic operator, the optimal solution of the problem is obtained until the termination condition of the algorithm is satisfied.

$${f}_{index} ( x , z ) = {\sum }_{i = 1}^{a - 1} {\sum }_{b = i + 1}^{a} [ \frac{\vert \frac{{m}_{cori}}{{m}_{corb}} - {( \frac{{\overline{n}}_{cori}}{{\overline{n}}_{cor b}} )}^{x} \vert}{\frac{{m}_{cori}}{{m}_{corb}}} ] + {\sum }_{i = 1}^{a - 1} {\sum }_{b = i + 1}^{a} [ \frac{\vert \frac{{φ}_{cori}}{{φ}_{corb}} - {( \frac{{\overline{n}}_{cori}}{{\overline{n}}_{cor b}} )}^{x - z} \vert}{\frac{{θ}_{cori}}{{θ}_{corb}}} ] \qquad ( 11 )$$

where a refers to a total number of known rotational speed curves, and each of the rotational speed lines has totally j operation conditions, which constitute j groups of similar operation conditions, so the j groups of similar operation conditions are optimized and ultimately optimal exponents xⱼ and zⱼ of the j groups of similar operation conditions are obtained: m_{cori} is a converted flow rate of the operation conditions of the rotational speed curve n̅_{cori}, and φ_{cori} is a pressure ratio efficiency coefficient of the operation conditions of the rotational speed curve n̅_{cori}, m_{corb} is a converted flow rate of the operation conditions of the rotational speed curve n̅_{corb}, φ_{corb} is a pressure ratio efficiency coefficient of the operation conditions of the rotational speed curve n̅_{corb}, and the subscript i, b refer to variables in the algorithm and refer to different rotational speed curves.

SS3. calculating the low rotational speed characteristic of the compressor.

Calculation flow charts of the flow rate, the pressure ratio and the efficiency are shown in FIGS. 4, 6 and 8 respectively. Applying the exponents xⱼ and zⱼ to the similar operation conditions of the respective rotational speeds as shown in equations (12) and (13). For each group of similar operation conditions, a polynomial fitting is applied to m̅_{cori}^{j} and φ̅_{cori}^{j} with respect to n̅_{cori} respectively, the fitting relations are equations (14) and (15), the converted flow rate m_{cor} and the pressure ration efficiency coefficient φ of the rotational speed curve may be calculated, as shown in equations (16) and (17). Then the pressure ratio π of the rotational speed curve to be obtained is calculated according to a coefficient fitting method. For a known rotational speed curve, a polynomial fitting is applied to the pressure ratio π with respect to the flow rate m_{cor}, and the fitting relationship is equation (18). A fitting is applied to the coefficient A_{bi} with respect to the relative converted rotational speed n̅_{cor}, as shown in equation (19), a relationship of π with respect to m_{cor} and n̅_{cor} is obtained as shown in equation (20), and the pressure ratio π of the rotational speed curve to be obtained is obtained. Finally, the efficiency ηₛ of the rotational speed curve to be obtained is calculated in accordance with equation (21).

m̅_{cori}^{j}=m_{cori}^{j}×(n̅_{cor0}/n̅_{cori})^{x}^{ⱼ} (12)

φ̅_{cori}^{j}=φ_{cori}^{j}×(n̅_{cor0}/n̅_{cori})^{z}^{ⱼ} (13)

Where subscript 0 refers to the operation condition of the rotational speed curve to be obtained, the subscript I refers to the operation condition of a known rotational speed curve, the superscript j refers to the group number of the similar operation conditions.

m̅_{cori}^{j}=Fⱼ(n̅_{cori}) (14)

φ_{cori}^{j}=Rⱼ(\hat{n}_{cori}) (15)

m_{cor}=Fⱼ(n̅_{cor0}) (16)

φ=Rⱼ(n̅_{cor0}) (17)

πᵢ=A₀ᵢ+A₁ᵢm_{cor}+ . . . +A_{ci}m_{cor}^{c} (18)

where A_{bi} (b=0, 1, . . . , c−1, c) is the coefficient of the fitting polynomial and the subscript i is the operation condition of the known rotational speed curve.

A_{bi}=g_{bi}(n̅_{cor}) (19)

π=G(m_{cor},n̅_{cor}) (20)

ηₛ=φ×(π^{(k-1)/k}−1) (21)

Verifying the Method.

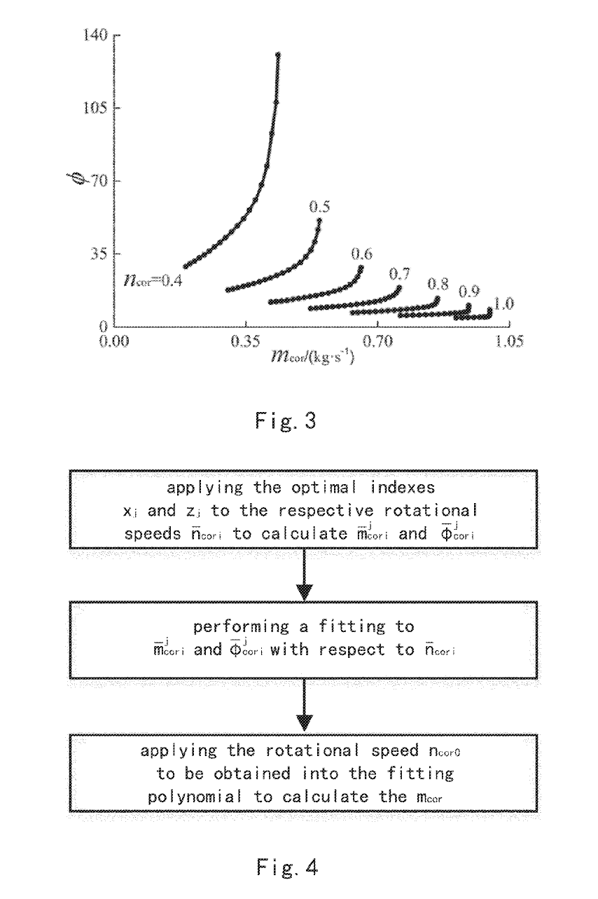

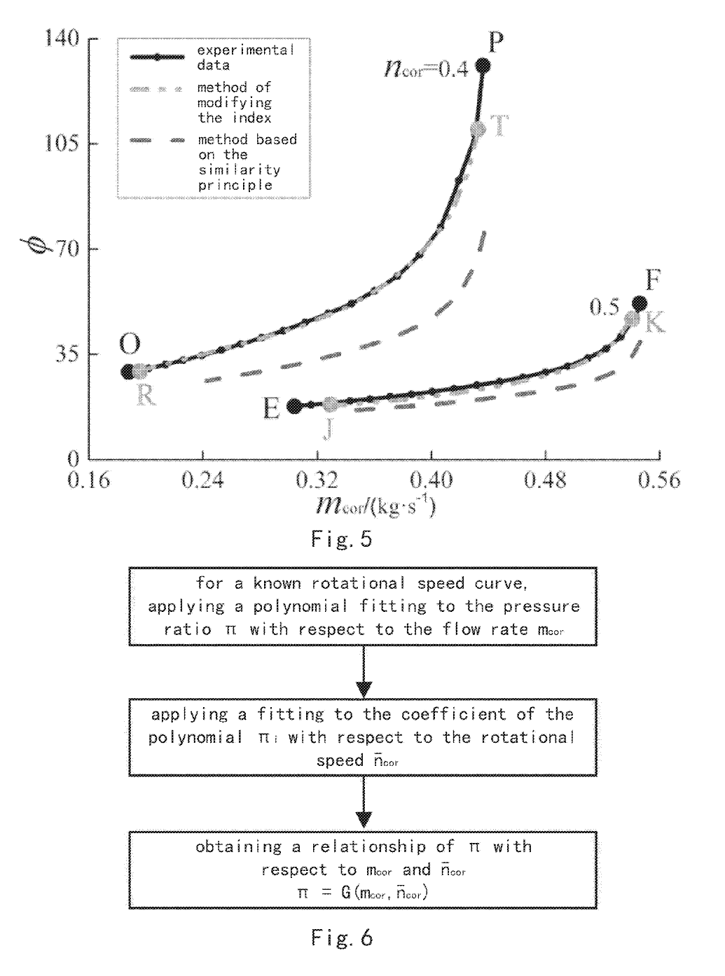

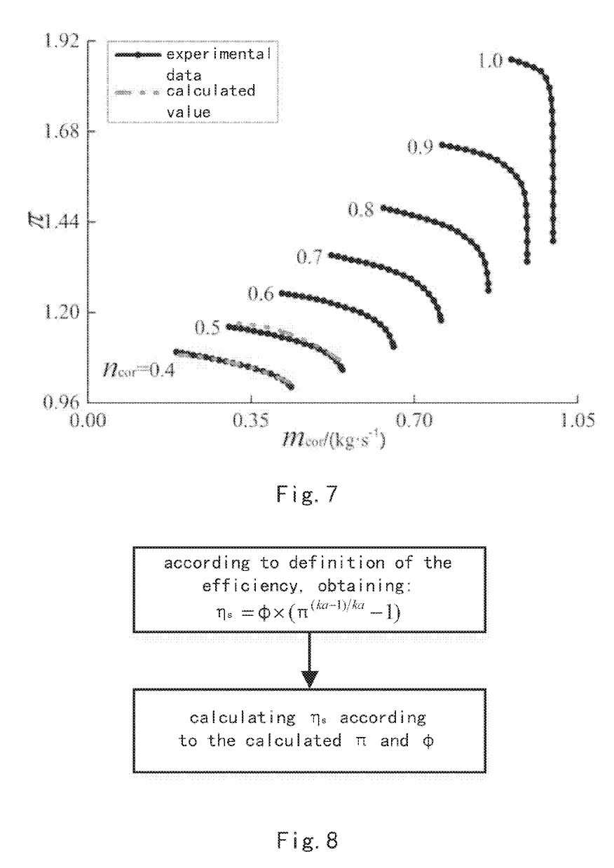

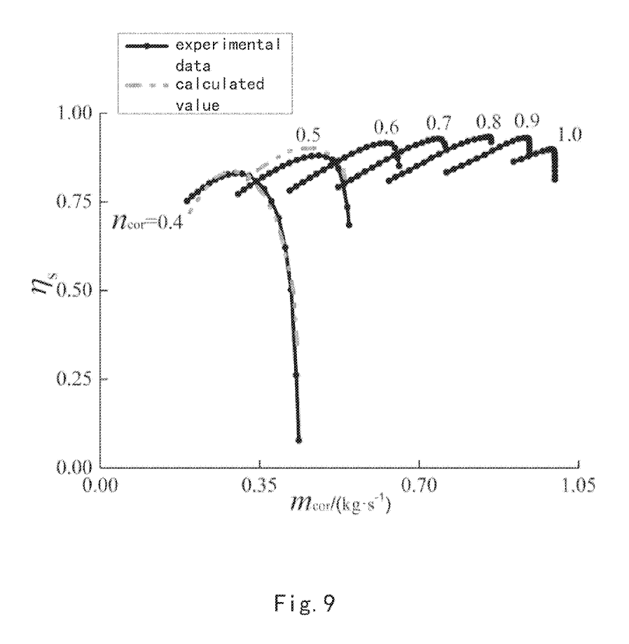

FIG. 3 is an experimental data of m_{cor}s−φ for a compressor of a turbofan engine of a certain type in which m_{cor}=0.9965, π=1.6989 and ηₛ=0.8915 are taken as the design points. The characteristic corresponding to n̅_{cor}=0.5 and n̅_{cor}=0.4 is calculated with the characteristic obtained when n̅_{cor}=0.6, n̅_{cor}=0.7, n̅_{cor}=0.8, n̅_{cor}=0.9 and n̅_{cor}=1, and m_{cor} and φ are calculated with a method of modifying the exponent. FIG. 5 shows comparison of the calculated m_{cor}, and φ by the method of modifying the exponent with the experimental data and the extrapolated results using the similarity principle directly. It can be known from FIG. 7 that the improved method and the original curve have a higher coincidence while φ calculated with the extrapolation method using the similarity principle directly have a maximum relative error close to 40%. After an analysis, the m_{cor}−π characteristic is of the highest accuracy when equation (18) is fitted by a quadratic polynomial and equation (19) is fitted by a quadratic polynomial. The fitted polynomial is expressed as equation (21′). FIGS. 7 and 9 show characteristics of the compressor which are calculated ultimately. It can be known from the figures that variations of m_{cor} and φ calculated with the optimal exponent are consistent with the actual curves and the coincidence degree is relative high, the error of the calculated value of 17, is less than 5%, which verifies the rationality of the method.

$${π}_{B} = {m}_{cor}^{2} \times ( - 7.4815 \times {\overline{n}}_{cor }^{2} - 0.8203 \times {\overline{n}}_{cor} + 0.4933 ) + {m}_{cor} \times ( 28.1118 \times {\overline{n}}_{cor}^{2} - 17.8079 \times {\overline{n}}_{cor} + 2.9647 ) - 13.3431 \times {\overline{n}}_{cor}^{2} + 11.4522 \times {\overline{n}}_{cor} + 1.3855 \qquad ( {21}^{′} )$$

With the above-described embodiment, the object of the present disclosure is fully and effectively achieved. It will be understood by those skilled in the art that the present disclosure includes, but is not limited to, the figures and descriptions described in the foregoing detailed description. Although the present disclosure has been described with respect to these embodiments, it is to be understood that the present disclosure is not limited to these embodiments, but that any modifications that do not depart from the function and structural principles of the present disclosure are included in the scope of the claims.

What is claimed is:

1. An extrapolation method of a low rotational speed characteristic of a compressor based on a similarity principle, comprising, in sequence, modifying the similarity principle, obtaining an optimal exponent, and calculating the low rotational speed characteristic of the compressor, wherein:
SS1. modifying the similarity principle includes:
taking into account the influence of gas compressibility on the exponent of the similarity principle, modifying equations of the similarity principle into equations (1)-(3), under a condition that an inlet angle of the compressor is constant, stages of an internal flow field of the compressor each satisfy a dynamic self-similarity, and an inlet and outlet speed-triangle under similar operation conditions satisfies a kinematic similarity and a geometric similarity:
$$\begin{matrix}\frac{{m}_{1}}{{m}_{2}} = {( \frac{{n}_{1}}{{n}_{2}} )}^{x} & ( 5 ) \\ \frac{{W}_{1}}{{W}_{2}} = {( \frac{{n}_{1}}{{n}_{2}} )}^{y} & ( 6 ) \\ \frac{{N}_{1}}{{N}_{2}} = {( \frac{{n}_{1}}{{n}_{2}} )}^{z} & ( 7 )\end{matrix}$$
where the equation (1) is a flow rate similarity equation, equation (2) is a work similarity equation, the equation (3) is a power similarity equation, x refers to an exponent of the flow rate similarity equation, y refers to an exponent of the work similarity equation and z refers to an exponent of the power similarity equation; m is a flow rate, W is the work of a compression shaft, N is the power of the shaft, n is a rotational speed, and the subscripts “1” and “2” refer to different operation conditions;
a relationship between the work and the flow rate of a working medium is known as follows:
W=N/m (4)
Derived by combining equations (1)-(4) is as follows:
$$\frac{{N}_{1} / {m}_{1}}{{N}_{2} / {m}_{2}} = {( \frac{{n}_{1}}{{n}_{2}} )}^{x - z} \qquad ( 5 )$$
the definition of isentropic efficiency is as follows:
$${η}_{s} = \frac{m \cdot {W}_{i}}{N} = \frac{m \cdot {C}_{p} ( {π}^{( ka - 1 ) / ka} - 1 )}{N} \qquad ( 6 )$$
where ηₛ is the compressor's isentropic efficiency, π is a pressure ratio, and ka is ta specific heat capacity ratio,
from equations (5)-(6), a relationship equation (7) between the efficiency and the pressure ratio based on the similarity principle is obtained as follows:
$$\frac{{η}_{s 1} / ( {π}_{1}^{( ka - 1 ) / ka} - 1 )}{{η}_{s 2} / ( {π}_{2}^{( ka - 1 ) / ka} - 1 )} = {( \frac{{n}_{1}}{{n}_{2}} )}^{x - z} \qquad ( 7 )$$
using a curve showing the pressure ratio π, the isentropic efficiency ηₛ, a relative converted rotational speed n̅_{cor} and a converted flow rate m_{cor} to express the characteristics of components of the compressor to obtain a further modified relationship equations (8)˜(10) of the similarity principle as follows:
$$\begin{matrix}\frac{{m}_{cor 1}}{{m}_{cor 2}} = {( \frac{{\overline{n}}_{cor 1}}{{\overline{n}}_{cor 2}} )}^{x} & ( 8 ) \\ \frac{{φ}_{1}}{{φ}_{2}} = {( \frac{{\overline{n}}_{cor 1}}{{\overline{n}}_{cor 2}} )}^{x - z} & ( 9 ) \\ φ = \frac{{η}_{s}}{{π}^{( ka - 1 ) / ka} - 1} & ( 10 )\end{matrix}$$
where
$${\overline{n}}_{cor} = \frac{n / \sqrt{{T}_{in}}}{{n}_{des} / \sqrt{{T}_{des}}}$$
is the relative converted rotational speed,
$${m}_{cor} = m \cdot \sqrt{\frac{{T}_{in}}{288.15}} \times \frac{101325}{{p}_{in}}$$
is the converted flow rate, Tᵢₙ is an inlet temperature, T_{des} is an inlet design temperature, n_{des} is a design rotational speed; pᵢₙ is an inlet pressure; among the subscripts, cor refers to a conversion parameter; φ is a defined pressure ratio efficiency coefficient,
SS2. obtaining the optimal index comprises establishing an objective function and optimizing the exponents, including firstly establishing an objective function as equation (11), secondly using the objective function as a fitness function, and optimizing the exponents by an optimization algorithm and obtaining optimal exponents xⱼ and zⱼ for j groups of similar operation conditions,
$${f}_{index} ( x , z ) = {\sum }_{i = 1}^{a - 1} {\sum }_{b = i + 1}^{a} [ \frac{\vert \frac{{m}_{cori}}{{m}_{corb}} - {( \frac{{\overline{n}}_{cori}}{{\overline{n}}_{cor b}} )}^{x} \vert}{\frac{{m}_{cori}}{{m}_{corb}}} ] + {\sum }_{i = 1}^{a - 1} {\sum }_{b = i + 1}^{a} [ \frac{\vert \frac{{φ}_{cori}}{{φ}_{corb}} - {( \frac{{\overline{n}}_{cori}}{{\overline{n}}_{cor b}} )}^{x - z} \vert}{\frac{{θ}_{cori}}{{θ}_{corb}}} ] \qquad ( 11 )$$
where a refers to a total number of known rotational speed curves, and each of the rotational speed curves has totally j operation conditions, which constitute j groups of similar operation conditions, so the j groups of similar operation conditions are optimized and ultimately optimal exponents xⱼ and zⱼ of the j groups of similar operation conditions are obtained: m_{cori} is a converted flow rate of the operation conditions of the rotational speed curve n̅_{cori}, and φ_{cori} is a pressure ratio efficiency coefficient of the operation conditions of the rotational speed curve n̅_{cori}, m_{corb} is a converted flow rate of the operation conditions of the rotational speed curve n̅_{corb}; φ_{corb} is a pressure ratio efficiency coefficient of the operation conditions of the rotational speed curve n̅_{corb}; the subscripts i, b refer to variables in the algorithm and refer to different rotational speed curves,
SS3. calculating the low rotational speed characteristic of the compressor comprises extrapolation calculation of the flow rate, extrapolation calculation of the pressure ratio and extrapolation calculation of the efficiency, wherein
the optimal exponents xⱼ and zⱼ are applied to the similar operation conditions of the respective rotational speeds as shown in Equations (12) and (13),
m̅_{cori}^{j}=m_{cori}^{j}×(n̅_{cor0}/n̅_{cori})^{x}^{ⱼ} (12)
φ̅_{cori}^{j}=φ_{cori}^{j}×(n̅_{cor0}/n̅_{cori})^{z}^{ⱼ} (13)
where m̅_{cori}^{j} is the relative converted flow rate, φ̅_{cori}^{j}, is the relative pressure ratio efficiency coefficient; the subscript 0 refers to the operation conditions of the rotational speed curve to be obtained, the subscript i refers to the operation conditions on a known rotational speed curve, the superscript j refers to the group number of the similar operation conditions;
for each group of similar operation conditions, a polynomial fitting is applied to m̅_{cori}^{j} and φ̅_{cori}^{j}, with respect to n̅_{cori} respectively, the fitting relations are equations (14) and (15), then the converted flow rate m_{cor} and the pressure ratio efficiency coefficient φ of the rotational speed curve to be obtained are calculated, as shown in equations (16) and (17):
m̅_{cori}^{j}=Fⱼ(n̅_{cori}) (14)
φ̅_{cori}^{j}=Rⱼ(n̅_{cori}) (15)
m_{cor}=Fⱼ(n̅_{cor0}) (16)
φ=Rⱼ(n̅_{cor0}) (17)
then the pressure ratio π of the rotational speed curve to be obtained is calculated according to a coefficient fitting method, which includes:
for a known rotational speed curve, performing a polynomial fitting to the pressure ratio π with respect to the flow rate m_{cor}, with the fitting relation in equation (18), and performing a fitting to the coefficient A_{bi} with respect to the relative converted rotational speed n̅_{cor}, as shown in equation (19), so that a relationship of π with respect to m_{cor} and n̅_{cor} is obtained as shown in equation (20), and the pressure ratio π of the rotational speed curve to be obtained is calculated as follows:
πᵢ=A₀ᵢ+A₁ᵢm_{cor}+ . . . +A_{ci}m_{cor}^{c}, (18)
A_{bi}=g_{bi}(n̅_{cor}) (19)
π=G(m_{cor},n̅_{cor}) (20)
finally calculating the efficiency ηₛ of the rotational speed curve to be obtained with equation (21):
ηₛ=φ×(π^{(k-1)/k}−1) (21)
where A_{bi} (b=0, 1, . . . , c−1, c) is the coefficient of the fitting polynomial and the subscript i refers to the operation condition of the known rotational speed curve.

2. The extrapolation method according to claim 1,
wherein the step SS1 further comprises investigating effects of the gas compressibility on the exponents of the similarity principle by investigating the difference between the exponent x in the flow rate similarity equation (1) and 1, or by investigating the difference between the exponent y in the work similarity equation (2) and 2, or by investigating the difference between the exponent z in the exponent of the power similarity equation (3) and 3.

3. The extrapolation method according to claim 1,
wherein the step SS2 further comprises, for each group of similar operation conditions, establishing an objective function with an object that the optimized exponents are obtained such that a sum of errors of the modified similarity principle between every two similar operation conditions is minimized.

4. The extrapolation method according to claim 1,
wherein the step SS2 further comprises optimizing the exponents by a genetic algorithm to obtain the optimal exponents xⱼ and zⱼ of j groups of similar operation conditions.

5. The extrapolation method according to claim 4, wherein when optimizing the exponents by the genetic algorithm, the method further comprises:
modeling an optimization problem as a process of biological evolution, and generating a better solution set generation by generation, choosing a better solution in each generation of solution set according to the fitness function value and generating the next generation of solution by crossing and mutating of the genetic operator, until evaluating to the largest genetic algebra, and ultimately obtaining the optimal exponents such that the sum of the errors of the modified similarity principle between every two similar operation conditions is minimized.

6. The extrapolation method according to claim 1, further comprising:
verifying the rationality of the calculated results by comparing them with experimental data and the extrapolated results obtained using the similarity principle directly.

7. The extrapolation method according to claim 1,
wherein the method is applicable to a device which needs to obtain the low rotational speed characteristic of a compressor, such as a gas turbine or an aircraft engine.
